(19) United States
(12) Patent Application Publication
(10) Pub. No.: US 2006/0273730 A1
(43) Pub. Date: Dec. 7, 2006

(54) GX10q combination for CFL's fixture

(76) Inventor: Da-Kuang Chang, New York, NY (US)

Correspondence Address: DA-KUANG CHANG, 87 Kathleen Dr., Syosset, NY, 11791, US

(21) Appl. No.: 11/149,505

(22) Filed: Jun. 2, 2005

(51) Int. Cl. H01J 13/46

(52) U.S. Cl. 315/56

(57) ABSTRACT

There are multiple adaptors or lamp holder in market to connect the power and pin based CFL. This innovation consists of a lamp-holder along with an easier replaceable Combination with integrally ballast circuit adaptor. This design is applicable to the use of GX10q based CFL. The purpose and special feature of this GX10q Combination being applied to pin-based CFL fixture, the internal ballast is easier replacement. Particularly when such design of GX10q Combination being adopted in recessed downlight & an attachment light kits for ceiling fan, the lamp will not be loosed and with its solid security and convenience accordingly

### CROSS-REFERENCES TO RELATED APPLICATIONS

N/A

### STATEMENT REGARDING FEDERALLY SPONSORED RESEARCH OR DEVELOPMENT

N/A

### REFERENCE TO A “MICROFICHE APPENDIX”

N/A

### BACKGROUND OF THE INVENTION

1. Field of the Invention

This invention is related to a CFL specific combination. Which is ballast's adaptor installed into an empty cylinder of GX10q lamp-holder. This Lamp-holder provides AC power as a suppler and also holding the GX10q pin based CFL, in which there are two lockers to lock the GX10q lamp's caps into the place.

2. Description of the Related Art

The GX10q is one kind of CFL lamp base upon IEC 61-2L 7005-84-2 which was twisted and locked into place so that the lamp would not fall out from the lamp-holder, which is an important factor in the use of CFL on recessed downlight and a light kit attached on ceiling fan.

### BRIEF SUMMARY OF THE INVENTION

When embodiment the adaptor internal ballast to set inner of the GX10q lamp holder shall be make sure the user won't mistake to install it. This invention designed two signs to helpful the user to installed that the integral adaptor into the place as well as a GX10q Combination. One important feature on body of adaptor has two concave lines one is from edge to edge another one just had half way long. Both engraved 1 m/m depth on body of adaptor. There are two convex lines as same as the length and width copied from body of adaptor on inside surface of the GX10q lamp holder. This design is ensure the adaptor one way to installed the place.

### BRIEF DESCRIPTION THE SEVERAL VIEWS OF THE DRAWING(S)

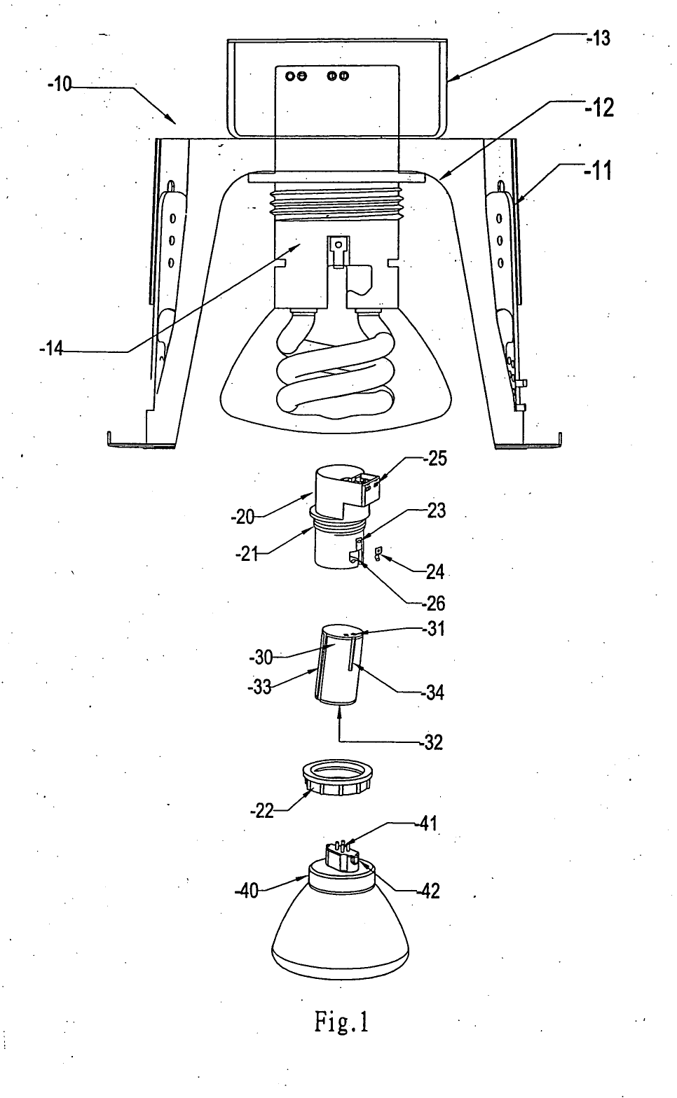

Please views of the drawing sheet 1 of 3. FIG. 1.—10 is a GX10q Lamp-holder Combination as showing as workout as a recessed downlight fixture.—20 Tabulate with empty cylinder, in which two locker—26 and the size on the diameter of the cylinder is suitable to the standard requirement of IEC 61-2L 7005-84-2, which allows the—42 the lamp caps of GX10q CFL can be installed exactly in place.—30 A cylinder shape adaptor consists of the part of electronic ballast which size and the dimension is design to be completely installed into the—20 GX10q lamp-holder. When the—30 adaptor has been installed into the functional place that which is touchable to get power supply for connectivity to—41 pin based—40 CFR-P38 lamp.

### DETAILED DESCRIPTION OF THE INVENTION

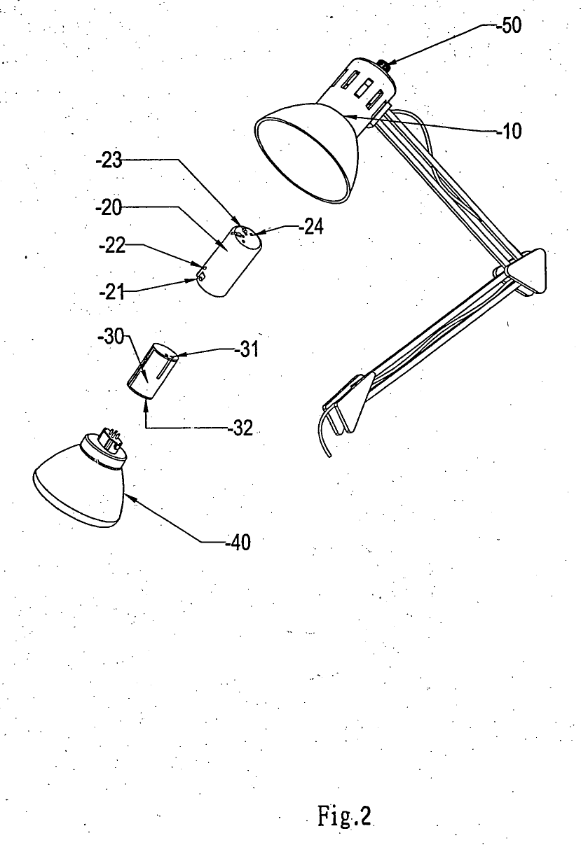

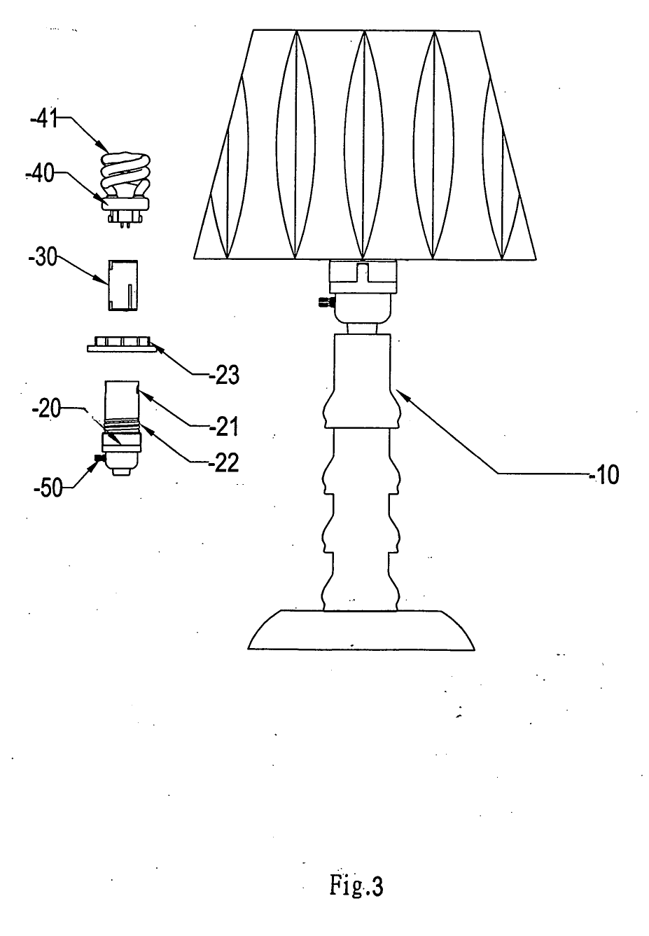

The drawing sheet 1 of 3—10 is use of the invention Combination of GX10q lamp-holder and a replaceable ballast are showing how to installed as well as a recessed downlight. FIG. 1.—10 is a recessed downlight kit.—11 is a frame—12 is a trim—13 is a junction box—14 is a GX10q lamp holder Combination.—20 are a GX10q lamp holder unit—21 are screw thread.—22 is a plastic ring to locking all the parts of the kit to assembling that as a unit.—23 two holes on body of GX10q lamp-holder—24 two brackets mounted though holes of—23 to holding the adaptor though lamp holder in order the adaptor won't fall from position place when replacement the lamp with base up—25 wire plug-in holes for AC power supply—26 GX10q lamp locker—30 is ballast's adaptor unit.—31 power input copper band—32 are power output copper band to connectivity to—41 bi-pin—40 CFR-P38 lamp.—33 Edge to edge engraved line to ensure one way to install the adaptor.—34 Half way engraved line as a stopper to stop wrong way to install the adaptor.—40 a CFR-P38 CFL lamp.—41 bi-pin cap of GX10q.—42 are hunger on both side to install the lamp into the place. The drawing sheet 2 of 3—10 is showing how to use the invention Combination of GX10q lamp-holder and replaceable ballast's adaptor to installed as well as Work light. FIG. 2.—20 is GX10q lamp-holder unit—21 is pin base cap's locker—22 Two holders to holding the adaptor inner of empty cylinder in order the adaptor won't fall from position place when replacement the lamp with base up—23 copper band to connected AC power supply—24 holes for fitting the Combination on the light kit.—30 is a ballast's adaptor unit—31 AC power input copper band—32 power output copper band to connectivity to—40 as same as mentioned on drawing sheet 1 of 3.—50 is dimmer switch. The drawing sheet 3 of 3—10 is showing how to use the invention Combination of GX10q lamp-holder and replaceable ballast's adaptor to installed as well as Portable light. FIG. 3.—20 is GX10q lamp-holder unit—21 is pin base cap's locker—22 is screw thread to locking the lamp shade in place—23 is plastic ring locker for lamp shade to locking in the place.—30 is an adaptor unit as same as mentioned—40 a GX10q lamp base.—41 a spiral type CFL tube—50 is a internal dimmer with ON-OFF switch, the same place for out door fixture will be changed a internal photocell.

1. A method of a replaceable ballast's adaptor set inner of a GX10q lamp holder as a Combination for pin based CFL's fixtures.

2. The method of claim 1 including of the power in-put & power out-put upon ballast internal adaptor is surface touched connected between GX10q lamp holder & pin based CFL.

3. The method of claim 2 including two concave & two convex lines on body of adaptor and on surface inside of empty cylinder of GX10q lamp holder.

4. The method of claim 3 including of the Combination used on recessed downright fixture as showing as on drawing sheet 1 of 3.

5. The method of claim 4 including the GX10q Combination used on wall mounted, ceiling mounted & work light, track light as showing as on drawing sheet 2 of 3.

6. The method of claim 5 including of the GX10q Combination used on portable fixture as showing as on drawing sheet 3 of 3.

7. The method of claim 6 including of an internal dimmer used in base of GX10q Combination for portable fixture as showing as on drawing sheet 3 of 3.

8. The method of claim 7 including of an internal photocell used in base of GX10q Combination for out door fixture as showing as on drawing sheet 3 of 3.
